(19) United States
(12) Patent Application Publication
(10) Pub. No.: US 2015/0251372 A1
(43) Pub. Date: Sep. 10, 2015

(54) SCRAP COMPACTING MACHINE

(71) Applicant: Cesare BONFIGLIOLI, BOLOGNA (IT)

(72) Inventor: Cesare BONFIGLIOLI, BOLOGNA (IT)

(21) Appl. No.: 14/637,646

(22) Filed: Mar. 4, 2015

(30) Foreign Application Priority Data
Mar. 4, 2014 (IT) RE2014U000004

(51) Int. Cl. B30B 9/32; B30B 15/08; B30B 15/00

(52) U.S. Cl. CPC B30B 9/326; B30B 15/0052; B30B 15/08

(57) ABSTRACT

A scrap compacting machine comprising a compacting channel in which a parallelepiped block of pressed scrap advances, a blade located at a downstream end of the channel, a portal structure having a vertical lie which is located above the end of the channel, in which a beam slides, which beam bears a blade complementary to the blade located at the end of the channel, at least a main activating hydraulic piston-cylinder group located between an architrave of the portal structure and the beam and in an adjacent position to each upright of the portal, at least an activating auxiliary hydraulic piston-cylinder group located between the respective upright and the respective end of the beam, said auxiliary piston-cylinder groups being activated by the same power hydraulic group that activates the at least a main hydraulic piston-cylinder group, and the overall active section of the auxiliary piston-cylinder groups being a fraction of the overall active section of the at least a main hydraulic piston-cylinder group.

The present invention relates to a press for metal scrap, able to reduce a disordered mass of scrap, including a mass of relevant dimensions, such as automobile body scrap, into parallelepiped blocks of pressed scrap.

Various types of press are known, in which the scrap fed in a disordered way by a hopper is pressed and advanced in a practically-horizontal compacting channel at the end of which it is separated into parallelepiped block.

The separation into parallelepiped blocks is carried out by a guillotine device, a blade of which is fixed to an end of the base of the compacting channel, while the other blade is fixed to a base of a sliding beam in a preferably perpendicular plane to the base of the channel.

The blade fixed to the sliding beam is slightly curved in a plane thereof, with a concavity thereof facing downwards. The vertically-sliding beam is guided internally of a portal structure, located straddling the base plane of the compacting channel, through which the blocks separated by the guillotine pass and then fall freely.

The architrave of the portal structure supports hydraulic means for activating the sliding beam which bears the blade.

As the resistance of the blade in its active stroke downwards is not constant, due to the irregular arrangement and conformation of the pieces of compacted scrap in the channel, the hydraulic activating means are preferably constituted by at least two piston-cylinder groups arranged in parallel in the sliding plane of the beam bearing the blade, with the aim of obtaining a better adaptation of the cutting force to the nature of the scrap.

These are two double-acting piston-cylinder groups, having a significant diameter, which for their activation require a considerable quantity of hydraulic fluid.

To overcome the resistance of the blade, the fluid must be supplied at high pressure, with comparatively reduced flow rates.

This configuration however exhibits the drawback that the upwards return stroke of the pistons, caused by the same flow rate which generates the active stroke, is very slow, which generates an equally slow return stroke of the blade, with a slowing-down that is often excessive with regard to working times.

The aim of the present patent is to obviate the above-described drawback with a solution that is simple, effective and economical.

This aim is attained by the invention, by a press having the characteristics set down in the independent claim.

The dependent claims relate to further advantageous characteristics of the invention able to improve effectiveness thereof.

In substance, in the invention activating auxiliary hydraulic means, such as an auxiliary piston-cylinder group, are located between the portal structure in which the beam bearing the blade slides and the beam itself, which auxiliary hydraulic means activate the beam bearing the blade in the return stroke thereof.

Since the force necessary to cause the raising of the beam is comparatively very much smaller than the force required in the active stroke of the beam, the section of the at least an auxiliary piston-cylinder group is very much smaller than that of the activating piston-cylinder group, so that the quantity of hydraulic fluid required for moving the auxiliary piston is very much smaller and the raising velocity of the beam in the return stroke is much greater than the velocity of the downwards-acting stroke.

Questions of regularity in the application of the forces responsible for the return of the beam, and questions of dimensions, make the adoption of two piston-cylinder groups advantageous, located in the vicinity of the uprights of the portal structure, and functioning in parallel.

On the basis of this configuration, it is possible not only to position the auxiliary piston-cylinder group externally of the compacting channel, but in a very much more lowered position with respect to the main piston-cylinder group.

The advantages and constructional and functional characteristics of the invention will emerge from the description that follows, which illustrates an embodiment thereof given by way of non-limiting example and illustrated in the accompanying figures of the drawings, in which:

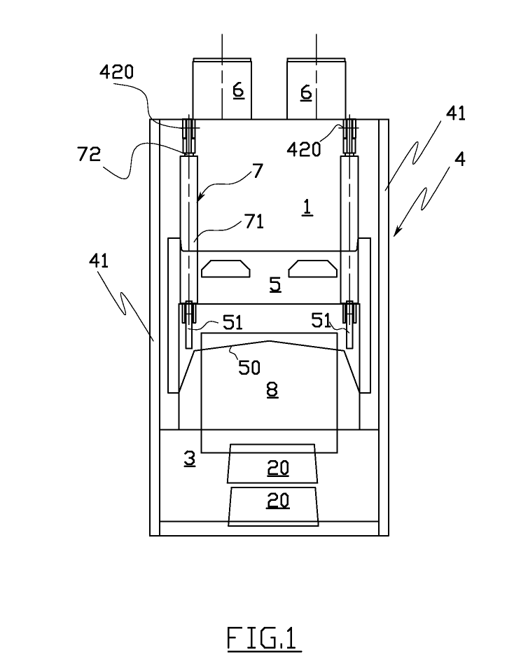

FIG. 1 illustrates the invention in a front view;

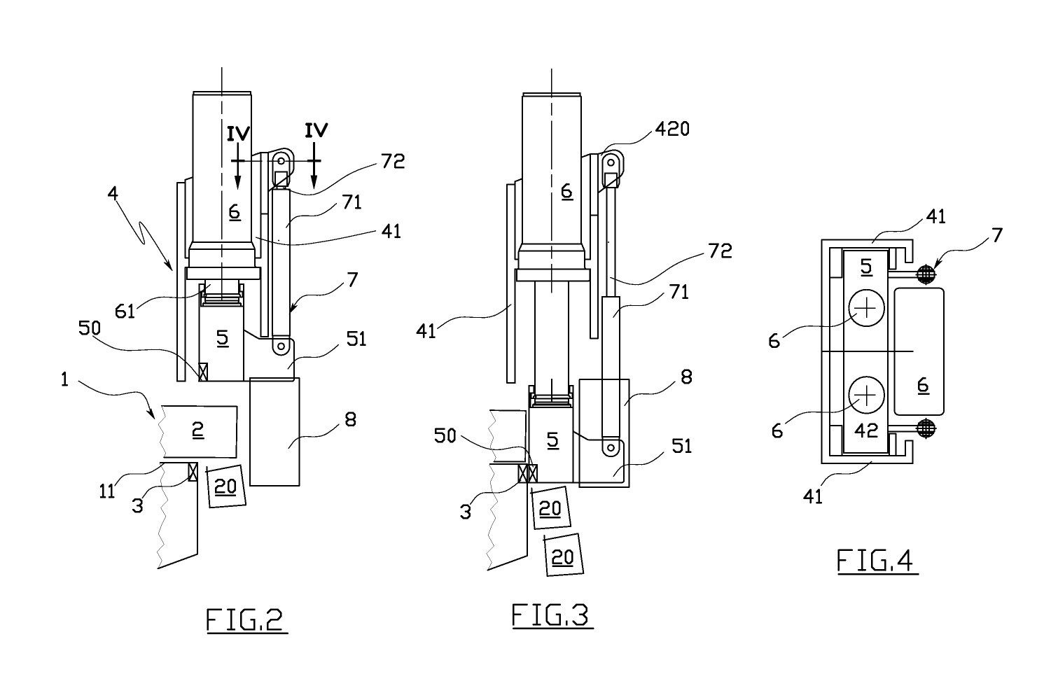

FIG. 2 illustrates the invention in a lateral view, with some components removed for the sake of clarity;

FIG. 3 shows the object of FIG. 2 in a different operative position;

FIG. 4 shows section IV-IV of FIG. 2.

The figures omit the part relating to the compacting of the scrap and the advancement thereof in the compacting channel, as these are not part of the invention and are well known to the expert in the sector.

With reference to the figures, the compacting channel 1 is illustrated, in which a continuous compacted block 2 of scrap is advanced on the base 11 by known means arranged upstream and not illustrated.

The compacting channel 1 can be slightly inclined downwards and comprises, in the front side of the base 11, a straight blade 3.

A portal structure 4 is arranged at the front side of the flat base, comprising two uprights 41 and an architrave 42, through which the continuous parallelepiped block 2 that is to be cut passes.

An abutting wall 8 is located at a distance from the front side and the portal, against which abutting wall 8 the continuous block rests before cutting.

While the block is resting against the abutting wall 8, suitable means (not illustrated as known) command the start of the cutting cycle.

The uprights 41 comprise the sliding guide of a beam 5, to which a blade is inferiorly fixed having a curved profile with a concavity facing downwards.

The blade 50 can collaborate with the blade 3 for separating the blocks 20 of scrap.

Two vertical-axis main piston-cylinder groups 6 are fixed to the architrave 42 of the portal structure 4, the beam 5 being fixed to the stem 61 of the two groups 6.

The activation of the beam in the cutting step of the block of scrap (descending stroke) is the task of the main piston-cylinder groups 6.

An auxiliary piston-cylinder group 7 is located adjacent to each of the uprights 41, which auxiliary piston-cylinder group 7 acts between the upright and the beam 5, and which has the task of activating the beam in the passive return stroke.

The body 71 of each auxiliary piston 7 is advantageously fixed to the respective end of the beam 5 by means of a shelf 51, and the stem 72 is fixed to the respective upright 41 by a shelf 420.

Each auxiliary piston-cylinder group is powered by the power group of the respective main piston-cylinder group, and therefore with a flow-rate p and a pressure Q.

The active diameter of the auxiliary piston-cylinder groups 7 is much smaller than the active diameter of the main piston-cylinder groups 6, and therefore the return stroke of the beam 5 bearing the blade 51 takes place at a much higher velocity than the descending velocity thereof.

The aim of the invention is therefore attained with a considerable reduction of the cutting cycle of the pressed blocks of scrap.

The blocks separated by the press according to the invention, after the separation, fall by gravity into suitable collection means from which the blocks are sent for storage or to subsequent work operations, such as break-up in appropriate mills.

It is understood that the invention is not limited to the above-described embodiment given by way of example, and that variants and improvement can be made thereto without forsaking the protective scope of the following claims.

1. A scrap compacting machine comprising a compacting channel (1) in which a parallelepiped block (2) of pressed scrap advances, a blade (3) located at a downstream end of the channel (1), a portal structure (4) having a vertical lie which is located above the end of the channel, in which a beam (5) slides, which beam (5) bears a blade (50) complementary to the blade (3) located at the end of the channel (1), at least a main activating hydraulic piston-cylinder group (6) located between an architrave (42) of the portal structure and the beam (5), characterised in that it comprises, in an adjacent position to each upright (41) of the portal, at least an activating auxiliary hydraulic piston-cylinder group (7) located between the respective upright and the respective end of the beam, said auxiliary piston-cylinder groups (7) being activated by the same power hydraulic group that activates the at least a main hydraulic piston-cylinder group (6), and the overall active section of the auxiliary piston-cylinder groups (7) being a fraction of the overall active section of the at least a main hydraulic piston-cylinder group (6).

2. The machine of claim 1, characterised in that two main hydraulic piston-cylinder groups (6) are located between the architrave (42) of the portal structure (4) and the beam (5).

3. The machine of claim 1, characterised in that the auxiliary piston-cylinder groups (7) exhibit the body (71) thereof connected to the beam bearing the blade and the stem (72) fixed to the upright of the portal structure.

4. The machine of claim 1, characterised in that the overall active section of the main piston-cylinder groups is greater than the overall active section of the auxiliary piston-cylinder groups.
